(19) United States
(12) Patent Application Publication
(10) Pub. No.: US 2021/0125024 A1
(43) Pub. Date: Apr. 29, 2021

(54) SELECTIVE DIELECTRIC COATING

(71) Applicant: T- Touch Internationa S.à.r.I., Luxembourg (LU)

(72) Inventors: Jan Thiele, Chemnitz (DE); Sascha Voigt, Bernsdorf (DE); Matthias Foerster, Dresden (DE); Karin Weigelt, Chemnitz (DE)

(73) Assignee: T - Touch International S.à.r.I., Luxembourg (LU)

(21) Appl. No.: 16/993,931

(22) Filed: Aug. 14, 2020

Related U.S. Application Data
(63) Continuation of application No. 15/525,175, filed on May 8, 2017, now abandoned.

(30) Foreign Application Priority Data
Nov. 7, 2014 (EP) 14192287.2

(51) Int. Cl. G06K 19/077; G06K 19/067; G06K 7/08; H04B 5/00

(52) U.S. Cl. CPC G06K 19/07788; G06K 19/067; H04B 5/0012; G06K 7/081; G06K 7/08

(57) ABSTRACT

The invention relates to a capacitive, planar information carrier with a first, second and third electrically conductive area wherein the first electrically conductive area is overprinted with a first dielectric layer having a first relative permittivity ε1 and wherein the third electrically conductive area is overprinted with a second dielectric layer having a second relative permittivity ε2. In another aspect, the invention relates to an information carrier formed from an electrically conductive surface of an object or an electrically conductive object. In other aspects, the invention relates to methods for the manufacture of information carriers, methods for detecting information carriers and to the use of an information carrier.

In the prior art, information carriers are described comprising electrically conductive structures that can be read by devices having a touch sensitive screen. For example in WO 2011/154524, a system comprising a capacitive information carrier for acquiring information is described. This invention relates to a system comprising a capacitive information carrier, wherein at least one electrically conductive layer is arranged on an electrically non-conductive substrate, and a surface sensor, wherein the two elements are in contact. Furthermore, the above-mentioned invention comprises a process for acquiring information, comprising a capacitive information carrier, a capacitive surface sensor, a contact between the two elements, and an interaction which makes a touch structure present on the information carrier evaluable for a data-processing system connected to the surface sensor and can trigger events that are associated with the information carrier.

In WO 2011/154524, a system for the transfer of information is provided, said system comprising at least
a capacitive information carrier, said information carrier having at least one electrically conductive layer arranged on an electrically non-conductive substrate and
a capacitive surface sensor,

wherein the information carrier is in contact with the surface sensor and the contact is preferably a static and/or dynamic contact. It is furthermore preferred that a capacitive interaction exists between the information carrier and the surface sensor. In the meaning of the invention, an information carrier is in particular a medium for the storage, replication, deposition and/or assignment of information.

The capacitive information carrier according to WO 2011/154524 comprises at least one electrically conductive layer, which is arranged as a touch structure on an electrically non-conductive substrate. The touch structure comprises of at least one coupling surface, which is preferably connected to at least one touch point via at least one conductive trace.

The system described in WO 2011/154524 allows for reading the capacitive information carrier by means of a capacitive surface sensor. Applications of this technology comprise for example playing cards, collectible cards, stamps, post marks, postal charges, goods logistics, goods tracking, admission systems, admission tickets, access to closed areas, virtual content, marketing applications, customer loyalty, lottery and prize competitions, membership passes, transit passes, payment applications, certificates of authenticity, protection from counterfeiting, copy protection, signatures, delivery notes, bank statements, patient information leaflets, objects within computer games, music/video/e-book downloads, bonus stamps/programs, device controls or gift cards without being limited to these.

The arrangement of at least one electrically conductive layer as a touch structure on an electrically non-conductive substrate, which comprises at least one touch point, a coupling surface and/or a conductive trace gives a certain level of reproducibility and recognition precision throughout the whole recognition process. The detection precision, i.e. the relative position of touch points detected by the data-processing system compared to the physical relative position of the touch points on the capacitive information carrier, is limited. These limitations are due to the nature of capacitive reading. It has been shown that not only the conductive areas representing the touch points cause changes in capacitance on the capacitive surface sensor, but also the conductive traces. Their geometry, in particular their size and their area, is designed in that way that the conductive traces will not trigger events by itself, but the conductive traces move the center of area of the actual touch points detected by the capacitive surface sensor. This causes slight deviations of the relative positions of the touch points detected by the data-processing system compared to the physical relative position of the touch points on the information carrier. These deviations have to be incorporated, when setting the tolerances or minimum “distances” of similar touch structures.

Following this approach, the conductive elements forming a touch structure can be grouped by their function into touch points, referred to as desired elements, and the coupling area and conductive lines, referred to as “necessary, but interfering elements”. The purpose of the touch points is to trigger events on the surface sensor. The purpose of the necessary, but interfering elements is to couple in a body capacitance of a human user and to connect galvanically the touch points with the coupling surface or with each other. These elements shall not trigger any events on the surface sensor.

The object of the present invention is therefore to provide an information carrier with an increased capacitive contrast between the desired elements and the necessary, but interfering elements on a touch screen to overcome the disadvantageous and drawbacks of the information carrier known from the prior art. In particular, it is preferred to enhance the capacitive contrast between the touch points on the one hand and the conductive traces on the other hand in order to improve the detection preciseness and to increase the number of different shapes of the electrically conductive structure which may be differentiated by a touch screen. Another object of the invention is to provide an information carrier formed from an electrically conductive surface of an object or an electrically conductive object. The object is achieved by the independent claims. Advantageous embodiments result from the dependent claims.

In one aspect, the present invention relates to a capacitive, planar information carrier with a front side and a back side, comprising an electrically non-conductive substrate and a first, second and third electrically conductive area wherein
a) the electrically conductive areas are applied at least on the front side of the information carrier,
b) a first dielectric layer with a first relative permittivity ε1 is arranged on top of the first electrically conductive area,
c) a second dielectric layer with a second relative permittivity a is arranged on top of the third electrically conductive area.

The touch structures known from the state of the art are usually overprinted with ink or covered by another non-conductive substrate to hide the touch structure visually. It has now been found that the dielectric properties of the cover layers, which are applied on the electrically conductive elements of the touch structure, influence the capacitive impact of the touch structure on the surface sensor. It was totally surprising that this finding is in particular true for the permittivity of the cover layers of the elements of the touch structure.

In the context of the present invention, it is preferred that the term “absolute permittivity” ε preferably represents a measure of how strong an electric field affects, and is affected by a dielectric medium. The permittivity of a medium preferably describes how much electric flux is generated per unit charge in that medium. Thus, it is preferred that permittivity relates to a material's ability to resist an electric field. The permittivity of a homogeneous material is preferably given relative to that of the vacuum permittivity ε₀, as a relative permittivity εₜ. In the context of this invention, it is preferred that the relative permittivity is also referred to as dielectric constant. In the context of the present invention, the touch points are overprinted by a first dielectric layer with a first relative permittivity ε1.

It is preferred that the side of the substrate where the touch structure is located is referred to as front side or A-side of the information carrier, whereas the other side is referred to as B-side of the information carrier or back side.

In the context of the present invention, the first electrically conductive area will preferably be referred to as touch point representing the element of the electrically conductive structure whose detection on a touch screen is desired and whose impact on a touch screen is intended to be enhanced by the present invention. The purpose of the touch points is preferably to trigger events on the surface sensor and/or to imitate the arrangement or properties of fingertips, wherein the properties of the touch points are described to the effect that said touch points can execute an input on a surface sensor like the tip of one or several fingers. It is particularly preferred that information is encoded by the position of touch points of the electrically conductive structure.

In the context of the present invention it is preferred that information is for example encoded by the overall shape of the first electrically conductive area and/or the electrically conductive structure formed from the first, second and third electrically conductive areas, the distances of the touch points to each other, the allocation and/or arrangement of the touch points on the information carrier, the angles which are enclosed by virtual lines connecting the touch points and/or the number of touch points.

The second electrically conductive area is preferably referred to as coupling surface, coupling area or contact area. The purpose of the coupling surface is to couple in the capacitance of a human user. The third electrically conductive area is preferably referred to as conductive trace or connecting line. The purpose of the conductive trace is to galvanically connect the touch points with the coupling surface or with each other. Thus, these elements, i.e. the coupling area and conductive traces, are needed for functionality reasons, but they are not supposed to interact with the touch screen themselves. It would be appreciated by a person skilled in the art, if these necessary, but interfering elements did not influence the detection process of the desired elements, i.e. the touch points, or if the capacitive impact of the necessary, but interfering elements on the touch screen can be reduced significantly compared to the impact of the touch points. It is preferred that the coupling area and the conductive traces represent the so-called “necessary, but interfering elements” causing undesired deviations of the touch point positions recognized by the touch screen. In the context of the present invention, the conductive traces are overprinted by a second dielectric layer with a second relative permittivity ε2. Preferably, the first relative permittivity ε1 is larger than the second relative permittivity ε2:

ε1>ε2

so that the capacitive impact of the electrically conductive elements covered with the first dielectric layer is stronger than impact of the electrically conductive elements covered with the second dielectric layer.

It came as a surprise that coating the touch points with a first dielectric layer having a specific first relative permittivity ε1 and coating the conductive traces with a second dielectric layer having a specific second relative permittivity ε2 can be used to improve the detection accuracy of the touch points by a surprisingly strong impact due to the different dielectric properties of the first and the second dielectric layers influencing the impact of the corresponding electrically conductive elements on the touch screen.

It is preferred that the first relative permittivity ε1 is larger than the second relative permittivity ε2. In this preferred case, the capacitive impact of the touch points which are preferably covered by the first dielectric layer with the first relative permittivity ε1 will be increased in absolute numbers and in particular in comparison to the impact of conductive traces which are preferably covered by the second dielectric layer with the second relative permittivity ε2.

The capacitive impact of the touch structure on the surface sensor is influenced by the relative permittivity εᵣ of the cover layer. Preferably, the relative permittivity is also denoted as Greek letter κ or k. It has surprisingly been found by the inventors that by virtue of the present invention an electrically conductive area covered with a high-k material having a larger dielectric constant has a stronger capacitive impact on a touch screen as a low-k material. To increase the difference of the capacitive impact on the surface sensor, it is preferred that at least two different materials with different permittivity values are used for covering the elements of the touch structure as dielectric layers. A so-called high-k material with a high permittivity is preferably used for covering the touch points, whereas a so-called low-k material with a low permittivity is preferably used for covering the conductive traces. These materials are preferably printed on the A-side of the information carrier covering the corresponding electrically conductive elements of the touch structure.

The preferred coating of the touch points with the high-k material having a high permittivity leads to the effect that the touch points create a greater impact on the capacitive surface sensor compared to conductive traces when the information carrier according to the present invention is brought in contact with the surface sensor with the A-side of the information carrier facing the surface sensor.

In the context of the present invention, it is preferred that the surface of the touch points and the conductive traces is covered exactly by the first and second dielectric layer. For some applications, it may also be preferred that the dielectric layers cover areas which may be slightly larger than the surfaces of the touch points and the conductive traces.

The capacitive impact of an electrically conductive component can be described by using the formula of a parallel-plate capacitor:

$$C = {ɛ}_{0} \cdot {ɛ}_{r} \cdot \frac{A}{d}$$

C . . . capacitance

ε₀ . . . vacuum permittivity (ε₀=8.8541878176·10⁻¹² F/m)

εᵣ . . . relative permittivity of the material

A . . . area of the parallel-plate capacitor

d . . . distance of the plates in the parallel-plate capacitor

As ε₀ is a constant, C can be increased by increasing εᵣ, increasing the area A and/or decreasing the distance d. A refers to the dimension of the touch points and is constant in this example. Thus, the present invention makes use of varying the relative permittivity of the material which is preferably also referred to as k in the context of the present invention.

In a further preferred embodiment of the invention, the first dielectric layer consists of a dielectric ink comprising a first relative permittivity ε1 of larger than 10, preferably larger than 20 and most preferably larger than 40. It is preferred that the touch points are covered with the first dielectric layer. It has been shown that even a material having a relative permittivity of larger than 10 is well suited for enhancing the capacitive impact of the touch points. Nevertheless, the strongest influence of the permittivity of a material on the capacitive impact of a touch point was achieved by the use of dielectric inks comprising a relative permittivity larger than 40. It noted that the values for the relative permittivity are given for the dried state of the inks. It is preferred that the term “in the dried state” is used for an information carrier according to the present invention whose manufacture is completed. That means that the electrically conductive areas and the dielectric layers are dry.

In a further preferred embodiment of the invention, the second dielectric layer consists of a dielectric ink comprising a second relative permittivity a of smaller than 4, preferably smaller than 3 and most preferably smaller than 2. It is preferred that this second dielectric layer is applied on the conductive traces. It was totally surprising that such a strong decrease of the capacitive impact of the conductive traces on a touch screen can be observed when the conductive traces are covered with the second dielectric layer.

It came as a surprise that even a permittivity in the range of less than 4 in the dried state for the second dielectric layer is well suited to decrease the capacitive impact of the connecting lines due to their specific line-like shape with a length l with is much larger than a width w of the conductive traces. Preferably, the first electrically conductive area is formed from sub-areas which represent the touch points of conventional information carriers. Preferably, their detection by the touch screen is desired, i.e. the touch points are supposed to trigger events on the touch screen. In the context of the present invention, the touch points have a dimension in the range of 1 to 20 mm, preferably 4 to 15 mm and most preferably 6 to 10 mm. If the touch points are for example designed circle-like, the term dimension may preferably refer to the diameter of the circles.

It came as a surprise that the decreasing impact of the second dielectric layer is due to polarization effects within the layer. The best overall decreasing effect is observed in connection with a second dielectric layer having a relative permittivity ε2 of smaller than 2 when applied on conductive lines.

In one preferred embodiment of the invention, the first electrically conductive area is overprinted with a dielectric layer comprising a relative permittivity larger than 40 while the third electrically conductive areas are overprinted with a dielectric layer comprising a relative permittivity of smaller than 2. This combination causes a high difference between the capacitive impact of these areas on a touch screen and strongly contributes to an accurate, fast and reliable detection.

In another preferred embodiment of the invention, the electrically conductive areas are in galvanic and/or electric contact. It is preferred that the elements of the electrically conductive structure formed by the touch points, the connecting lines and the contact area, are linked with each other. This means in the context of the present invention that each element has at least one connection with another element of the electrically conductive structure. For example, it may be preferred that the touch points are arranged in a line and that two touch points are connected by a conductive trace. It may, for other purposes, also be preferred that the touch points form, for example, a circle structure where the touch points are inter-connected. It may also be preferred that the contact area is connected to at least one of the touch points by at least one conductive trace.

The term “in galvanic and/or electric contact” means in the context of the present invention that the electrically conductive structure is suited to conduct electricity. Thereby, any changes to electric and/or galvanic properties, which are applied to one element of the electrically conductive structure, are transmitted within the structure so that the impact of the change is evenly distributed to all elements of the electrically conductive structure.

For some applications, it may be preferred that the coupling area is also covered with a high-k dielectric material and/or layer. As described above, the coupling area is used to couple in the electrical potential of a user when the information carrier is brought into contact with a capacitive surface sensor. Bringing into contact preferably means, that the touch points and conductive traces are placed on the surface of a touch screen while the coupling area is situated outside the screen. By this preferred embodiment of the invention, the user can easily access the coupling area to set the entire conductive layer, i.e. touch points, conductive traces and coupling area, on his potential. One the other hand, the coupling area will not trigger touch events since it is not in contact with the touch screen. To improve the transmission of the potential of a user to the touch points over conductive traces, it may therefore be preferred to apply a high-k dielectric onto the coupling area.

Surprisingly, the detection of the capacitive information carrier will also work properly if a low-k dielectric is printed on top of the coupling area, as may be preferred for some specific applications of the invention. That might e.g. appear if the touch points shall be visually highlighted by the first dielectric layer. It may be also preferred that neither a high-k nor a low-k dielectric is printed on top of the coupling area.

In a further embodiment of the invention, the areas of the non-conductive substrate, which are not covered with an electrically conductive area, may be covered with a low-k or high-k dielectric material and/or layer. Preferably, a low-k dielectric is applied on top of these areas which are not covered with any elements of the electrically conductive structure. Surprisingly, covering these areas with a high-k dielectric will not disturb the detection of the touch points. This is due to the fact the no electrically conductive material is printed on those areas. Advantageously, these areas may be overprinted by low-k or high-k dielectric materials and/or layers in order to compensate any differences in height that may occur by overprinting the electrically conductive areas with a dielectric ink.

It came as a surprise, that the detection deviations that may be caused by the necessary, but interfering elements, in particular the conductive traces, can be reduced significantly by the preferred embodiments described above.

In another preferred embodiment of the invention, the electrically non-conductive substrate is made from flat, flexible, non-conductive materials selected from a group comprising paper, cardboard, plastic, wood-based material, composite, glass, ceramic, textile, leather and/or any combination thereof. It is preferred to use a flexible material as the flexibility of the substrate material simplifies the manufacture process and enables for a wider range of manufacture and printing methods to be applied. If plastics are employed, it is preferred to use PVC, PETG, PETX, PE, PP, PC, PS and synthetic papers.

In case that cardboards are used, it is preferred to use either coated cardboards or uncoated cardboards, depending on the purpose of the application. It may also be preferred to use light-permeable or light-impermeable substrates depending on the desired outer appearance of the end product. It has been shown that a preferred thickness of the substrate is in a range of 20-2000 μm, more preferred 50-1000 μm, most preferred 150-500 μm.

It is preferred that the capacitive information carrier is a flat product, e.g. a card, a coaster, a label and the like. It may be also preferred that the capacitive information carrier is part of a spatial object, e.g. a package. The term “spatial object” preferably refers to a 3D object having a length, width and height which is e.g. larger than 0.5 cm. In the context of the present invention, it is preferred that a spatial object is in particular not a flat object like a card.

In another preferred embodiment of the invention, the electrically conductive areas are manufactured with additive printing methods selected from a group comprising offset printing, flexo printing, gravure printing, screen printing and/or digital printing. It was totally surprising that resulting film thickness is homogenous over the whole printed area when using the given printing methods. It also came as a surprise that the layers, i.e. the electrically conductive structure and the dielectric materials, can advantageously be printed using the same print process. More advantageously, the layers can be printed inline in one machine pass. In the context of the present invention, it is preferred that only one side of the substrate is printed. It was totally surprising that the conductive elements are manufactured preferably in one process step by the same method and using the same material. Advantageously, mass production methods like printing processes are preferred for the manufacture of the information carrier according to the present invention in order to have the opportunity to produce high volumes at low costs.

In another preferred embodiment of the invention, the electrically conductive areas are manufactured with a chemical deposition method, a physical vapour deposition and/or a sputtering process. In the context of the present invention, it is preferred that vapour deposition processes are used to produce high-purity, high-performance solid materials. In the chemical deposition process, the substrate is preferably exposed to one or more volatile precursors which advantageously react and/or decompose on the substrate surface to produce the desired deposit. Physical vapour deposition preferably describes a variety of vacuum deposition methods used to deposit thin films by the condensation of a vaporized form of the desired film material onto a substrate. It is preferred that physical vapour deposition involves purely physical processes such as high-temperature vacuum evaporation with subsequent condensation, or plasma sputter bombardment rather than involving a chemical reaction at the surface to be coated as in chemical vapor deposition.

It is also preferred that the electrically conductive elements can be applied to the substrate by a sputtering process. The term “sputtering” preferably refers to a process where atoms are ejected from a solid target material due to bombardment of the target by energetic particles. This process is preferably driven by momentum exchange between the ions and atoms in the materials, due to collisions. Layers of electrically conductive material applied by the above-mentioned deposition methods have advantageous mechanic properties as they are harder and more corrosion resistant than coatings applied by other processes known to a person skilled in the art. Most coatings applied by a sputter process have high temperature resistance and enhanced impact strength, good abrasion resistance and are so durable that additional protective coatings are not necessary. Chemical and physical vapour deposition methods enable advantageously for a large variety of different materials to be applied on a substrate.

In another preferred embodiment of the invention, the material of the electrically conductive areas is selected from a group comprising metal particles, nanoparticles, in particular silver, gold, cooper, and/or aluminum, electrically conductive particles, in particular carbon black, graphite, graphene, ATO (antimony tin oxide), electrically conductive polymer layer, in particular Pedot, PANI (polyaniline), polyacetylene, polypyrrole, polythiophene, pentacene or any combination thereof. Further preferred materials might be salts, electrolytes, inks, fluids or any combination thereof.

It has been found that electrically conductive elements consisting of the given materials enable for a significantly improved galvanic and/or electrical contact between the single electrically conductive elements and a good electrical conductivity within the electrical conductive structure. It was totally surprising that such a large number of different materials can be used to manufacture the electrically conductive elements of the information carrier, giving way to a great flexibility regarding the production process of the conductive elements. What is more, it is easy to adapt an information carrier according to the present invention to certain applications where pre-defined features have to be met.

In another preferred embodiment of the invention, the dielectric layers are manufactured with an additive printing method selected from a group comprising offset printing, flexo printing, gravure printing, screen printing and/or digital printing. As described above, this advantageously enables for manufacturing the information carrier according to the present invention with only one machine pass thus reducing the manufacturing costs and personnel efforts.

It is preferred that materials for the manufacture of the high-k dielectric layer is selected from a group comprising ceramic filled inks, e.g. titanium dioxide, barium titanate, strontium titanate or lead zirconate titanate without being limited to these materials. A person skilled in the art recognizes from the list of given materials the preferred properties of the materials used for the manufacture of the dielectric layers and will be able to apply this knowledge to materials that will be available in the future. In the context of the present invention, it is preferred that high-k dielectric materials have a relative permittivity larger than 10.

It is preferred that materials for the manufacture of the low-k dielectric layer are selected from a group comprising common printing inks, varnishes and any other materials which are usually used in print production. In the context of the present invention, it is preferred that low-k dielectric materials have a relative permittivity smaller than 4.

In another aspect, the invention relates to a method for manufacture of an information carrier according to the present invention comprising the following steps
a) Providing an electrically non-conductive substrate,
b) Application of a first, second and third electrically conductive area on the electrically non-conductive substrate,
c) Application of a first dielectric layer comprising a dielectric ink comprising a first relative permittivity ε1 on top of the first electrically conductive area,
d) Application of a second dielectric layer comprising of a dielectric ink comprises a second relative permittivity ε2 on top of the third electrically conductive area

It is preferred that the method according to the present invention in particular comprises the printing of one or more layers of conductive ink onto a non-conductive substrate, the printing of one or more layers of a dielectric layer with high permittivity ε1 onto the touch points and the printing of one or more layers of a dielectric material with low permittivity a onto the conductive traces.

In another preferred embodiment of the invention, the first dielectric layer comprises a first relative permittivity ε1 of larger than 10, preferably larger than 20 and most preferably larger than 40 in the dried state. It is also preferred that the second dielectric layer comprises a second relative permittivity ε2 of smaller than 4, preferably smaller than 3 and most preferably smaller than 2 in the dried state.

In another aspect, the invention relates to a method for detecting an information carrier according to the present invention by a touch screen wherein the front side of the information carrier is brought in contact with a touch screen. In the context of the present invention, it is preferred that the electrically conductive structure and the dielectric layers are printed on the front side of the information carrier, which is preferably also referred to as A-side. Thus, the desired increase of the capacitive contrast of the different elements of the electrically conductive structure is strongest when the information carrier is detected by bringing its front side into close contact with the touch screen.

In another aspect, the invention relates to the use of an information carrier according to the present invention wherein the first electrically conductive area generates a local change of capacitance on a touch screen by bringing into contact the information carrier with a touch screen. The change of capacitance on the touch screen is advantageously caused by bringing into contact the touch screen and the information carrier according to the invention wherein the information carrier faces the touch screen with its front side. Preferably, this contact is a static and/or dynamic contact. In the sense of the present invention, a static contact is a contact where the position of the information carrier on the touch screen does not change. A dynamic contact refers to a contact where at least one of the two devices, i.e. touch screen and information carrier, is in motion.

In the following, calculation examples are shown for low-k and high-k materials illustrating the mode of action of the two dielectric layers. The calculation examples are based on the following equation that has been mentioned in the description of the present invention:

$$C = {ɛ}_{0} \cdot {ɛ}_{r} \cdot \frac{A}{d}$$

Calculation Example for Low-k Elements:

| | |
|---|---|
| ε₀ | vacuum permittivity (ε₀ = 8.8541878176 · 10⁻¹² F/m) |
| εᵣ | =2 (low-k ink) |
| A | 50.3 · 10⁻⁶ m² (for an average touch point size) |
| d | 5 μm (average thickness of dielectric layer) |
| | → C_{low}/A = 3.54 · 10⁻⁶ F/m² |

Calculation Example for High-k Elements:

| | |
|---|---|
| ε₀ | vacuum permittivity (ε₀ = 8.8541878176 · 10⁻¹² F/m) |
| εᵣ | =40 (high-A ink) |
| A | 50.3 · 10⁻⁶ m² (for an average touch point size) |
| d | 5 μm (average thickness of dielectric layer) |
| | → C_{high}/A = 70.8 · 10⁻⁶ F/m² |

The proportion of C_{low}/A to C_{high}/A is 1:20, i.e. the capacitive impact of the touch points overprinted with high-k material, is 20 times higher compared to the “necessary, but interfering elements” which are overprinted with low-k material.

By the advantageous design of the information carrier according to the present invention, the capacitive interaction between the touch points and the touch screen is rendered stronger and more reliable, as essentially only the touch points of the information carrier are recognized by the touch screen. Therefore, the deviation with which the position of a specific touch point is detected can be reduced significantly by the software and therefore the detection preciseness enhanced, as the physical position of the touch point can be detected more clearly and less prone to error due to the advantageous use of high-k ink.

With conventional information carriers, the touch points are detected by capacitive reading devices with certain deviations from their real physical position. This shift is due to the capacitive impact of the conductive traces and the coupling area as they influence the detection and evaluation of the capacitive signal by the touch controller of the touch screen. It came as a surprise that such deviations and positions shifts may significantly be reduced when using information carriers according to the present invention. Test have shown that these undesired shifts and deviations are reduced by at least 50% compared to conventional information carriers if a low-k material with εᵣ=2 and and high-k material with εᵣ=40 is used. This surprising effect is due to the overprinting of the touch points with high-k material with εᵣ=40, thus promoting the capacitive impact of the touch points on the touch screen, and to the overprinting of the conductive traces with a low-k material with εᵣ=2, thus minimizing their effect on the touch screen. This effect occurs in particular in connection with a touch screen which was not to be expected by a person skilled in the art.

In a preferred embodiment of the invention, an information carrier is formed from an electrically conductive surface of an object or an electrically conductive object, wherein a first part of the electrically conductive surface of an object or the electrically conductive object is covered by a dielectric layer with a first relative permittivity ε1 generating a first signal on a capacitive reading device.

In the context of the present invention, it is preferred that an object may be any electrically conductive or electrically non-conductive object. Preferably, the object may be a 3D object, e.g. an aluminum can, or a flat object, such as, for instance, a card, a label, a tag or the like. This object comprises an electrically conductive surface.

Alternatively, it is preferred to use an electrically conductive object as a substrate for the application of layers with dielectric materials with different permittivities ε₁. In the context of the present invention, it is preferred that an electrically conductive object is an object which represents an electrically conductive body as a whole. For example, the term may relate to a plastic bottle made of electrically non-conductive plastic material, which is filled with an electrically conductive material, e.g. an electrically conductive fluid such as an electrolyte.

Preferably, said dielectric layer consists of a dielectric ink comprising a first relative permittivity ε1 of larger than 10, preferably larger than 20 and most preferably larger than 40.

In the context of the present invention, it is preferred that information may be encoded within the first part of the electrically conductive surface of an object or the electrically conductive object. Advantageously, the information may easily be detected by the use of capacitive reading device. It is noted that the term “capacitive reading device” is not limited to a capacitive surface sensor such as a touch screen in this particular embodiment of the invention, but may in particular refer to a specific reading device which is suited for any kind of capacitive sensing. It is preferred that the term “first part of the electrically conductive surface of an object or the electrically conductive object” refers to a specific part of the electrically conductive surface of an object or the electrically conductive object itself. It is preferred that this first part of the electrically conductive surface of an object or the electrically conductive object comprises at least one sub-area.

It was totally surprising that a fully conductive surface may be used to create preferably different signals on a capacitive reading device by applying two different dielectric materials on the surface.

The first part of the electrically conductive surface of an object or the electrically conductive object may preferably be overprinted with a high-k dielectric material that creates a high capacitive impact of the sub-areas forming the first part of the electrically conductive surface of an object or the electrically conductive object. It is preferred that the layer thickness of the high-k material is higher or at least equal compared to the thickness of the low-k material to prevent air gaps between the sub-areas and the capacitive reading device. The low-k material may preferably be printed on a second part of the electrically conductive surface of an object or the electrically conductive object.

It was totally surprising that by the preferred embodiment even fully conductive objects or objects with an electrically conductive surface can easily be used to encode information. Moreover, this advantageously enables applications that have not been disclosed by prior art. By the preferred embodiment, fully conductive packages, packages containing aluminum, other electrically conductive materials or conductive contents may advantageously be used to decode information. The invention surprisingly allows using metallized substrates in general to be used for decoding information on a capacitive surface sensor.

In a preferred embodiment of the invention, a second part of the electrically conductive surface of an object or the electrically conductive object is covered by a dielectric layer with a second relative permittivity ε2 and/or a low-k spacer material generating a second signal on a capacitive reading device, wherein the first and the second part form the electrically conductive surface of an object or the electrically conductive object which is read by the capacitive reading device. If, for example, the object is a can or a bottle, it may suffice to overprint a first and/or a second part on the base of the bottle or the can.

In the context of this embodiment, the term of a “dielectric layer with a second relative permittivity ε2” preferably refers to a layer consisting of a low-k ink, wherein a low-k ink preferably corresponds to a relative permittivity ε2 of smaller than 4, preferably smaller than 3 and most preferably smaller than 2 in the dried state. Inventors have found that the most preferred low-k dielectric available is air having a relative permittivity of εᵣ=1. Thereby, it has been found that a printing ink having a relative permittivity close to this relative permittivity εᵣ=1 is best suited for the purpose of these embodiments.

In the context of the present invention, a low-k ink is preferably printed on the electrically conductive surface of an object or printed on an electrically conductive object with a coverage of 100%. In the context of the present invention, it is preferred that a low-k spacer is printed partly on the conductive surface of the object, e.g. by small dots in a certain distance to each other. This advantageously causes an air buffer. In a preferred embodiment, this advantageously leads to a reduced capacitive impact of the second part of the electrically conductive surface of an object or the electrically conductive object, i.e. the capacitive impact of the second part which is covered with the low-k spacer is reduced compared to the capacitive impact of the electrically conductive surface of the object where no low-k spacer is applied. Thereby, the second part advantageously causes a second signal on a capacitive reading device.

Preferably, the low-k spacers are formed from hills; in other words, they are preferably raised compared to the surface they are applied to. They have a specific height, diameter and distance from each other, wherein these dimensions may advantageously be adapted to specific applications of the information carrier. In the context of the present invention, it is preferred that the low-k spacers are raised so that they may not easily be levelled to the initial state.

In the context of the present invention, it is preferred that the sum of the first and the second part of the electrically conductive surface of an object or the electrically conductive object corresponds to the total surface area of the electrically conductive surface of an object or the electrically conductive object which is read by the capacitive reading device. This preferably means that the second part of the electrically conductive surface of an object or the electrically conductive object preferably corresponds to the total surface area of the electrically conductive surface of an object or the electrically conductive object minus the first part; in other word, the second part preferably represents the remaining part of the total surface area which is read by the capacitive reading device after the first part of the electrically conductive surface of an object or the electrically conductive object has been overprinted by a first dielectric layer with a high-k material.

In a further aspect, the invention relates to a use of an information carrier wherein the first signal generated by the first part of the electrically conductive surface of an object or the electrically conductive object is different from the second signal generated by the second part of the electrically conductive surface of an object or the electrically conductive object.

Preferably, the capacitive reading device detects both the first and the second part of the electrically conductive surface of an object or the electrically conductive object. In the context of the present invention, it is preferred, however, that the two parts which are overprinted with dielectric materials which differ in their relative permittivity are accorded different signals whose strengths depend on the relative permittivity ε of each part. It is preferred that the first part which comprise dielectric material with a high-k permittivity ε1 generate a first signal on the capacitive reading device which is different from the second signal generated by the second part of the electrically conductive surface of an object or the electrically conductive object comprising dielectric material with a low-k permittivity ε2. For example, it may be preferred that the controller of the capacitive reading device assigns a first signal corresponding to “1” to the sub-areas with a high-k permittivity ε1 and a second signal corresponding to “0” to the part with a low-k permittivity ε2, wherein a signal “0” may be referred to as a “non-signal” in the context of the present invention.

In the context of the present invention, it is preferred that the first part, i.e. the sub-areas forming the first part, causes a first signal that may be read by a capacitive reading device. Preferably when brought into contact with a capacitive reading device, a capacitor is formed from the first part of the electrically conductive surface of an object or the electrically conductive object on the one hand and the electrodes of the capacitive reading device, wherein the absence or presence of a first and/or a second part of the electrically conductive surface of an object or the electrically conductive object advantageously influences the electric field which is present between the components of the capacitor.

In another preferred embodiment, the first part, i.e. the sub-areas forming the first part, imitates the arrangement, properties and/or physical effects which fingertips may trigger on a capacitive reading device. The term “properties” may preferably refer to the electric properties, such as capacitance, conductivity, permittivity, without being limited to it, and/or mechanical properties, such as dimensions, shape, size, geometry, arrangement, without being limited to it. The term “arrangement” preferably refers to the way at least one fingertip may be arranged with respect to a capacitive reading device, as the number of different arrangement of a specific number of fingertips is limited in variation by anatomical limitations of the human hand. The term “physical effect” preferably refers to the effect which is caused by the first part of the electrically conductive surface of an object or the electrically conductive object on the capacitive reading device. For this preferred embodiment of the invention where the sub-areas of the first part imitate the arrangement, properties and/or physical effects of fingertips, it is preferred that the capacitive reading device is represented by a touch screen. For other applications in the context of the present embodiment, it may be preferred to detect the information carrier with a specific capacitive reading device, wherein the term “specific capacitive reading device” refers to capacitive reading devices which are specifically developed for detecting information carriers according to the present invention.

Moreover, it is preferred that the second part of the electrically conductive surface of an object or the electrically conductive object generates a second signal which may be detected by the capacitive reading device. In some embodiments it may be preferred that the signal, preferably the second signal, lies under a certain threshold so that it will preferably be interpreted by the capacitive reading device as a non-signal due to the weakness of the signal.

In a further aspect, the invention relates to a method for manufacture of an information carrier, comprising the following steps:
a) Providing an electrically conductive surface of an object or an electrically conductive object
b) Application of a dielectric layer with a first relative permittivity ε1 onto the first part of the electrically conductive surface of an object or the electrically conductive object.

In another preferred embodiment, the invention relates to a method for manufacture of an information carrier comprising the following steps:
a) Providing an electrically conductive surface of an object or an electrically conductive object
b) Application of a dielectric layer with a first relative permittivity ε1 onto the first part of the electrically conductive surface of an object or the electrically conductive object.
c) Application of a dielectric layer with a second relative permittivity ε2 and/or a low-k spacer onto the second part of the electrically conductive surface of an object or the electrically conductive object.

In a further aspect, the invention relates to a method for the detection of an information carrier, wherein the information carrier is brought into contact with the capacitive reading device.

These and other objects, features and advantages of the present invention will best be appreciated when considered in view of the following description of the accompanying drawings:

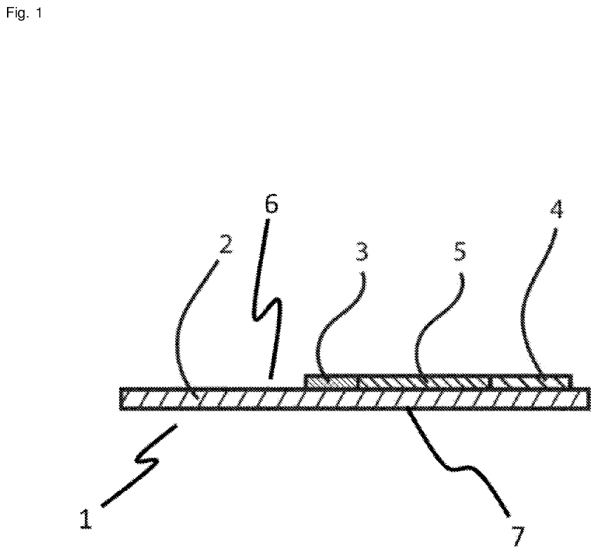

FIG. 1 shows a side view of an information carrier where steps a) and b) of the method of manufacture have been carried out, i.e. the electrically non-conductive substrate has been provided and the electrically non-conductive areas have been applied to the front side of the substrate.

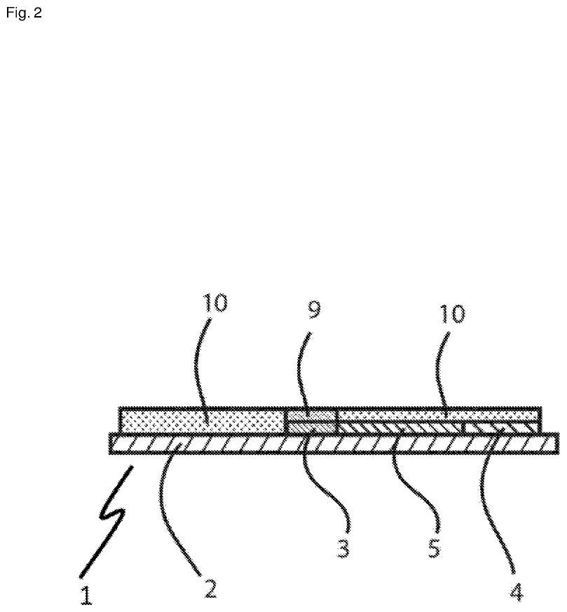

FIG. 2 shows a side view of an information carrier where the method of manufacture has been completed, i.e. the dielectric layers have been applied to the information carrier.

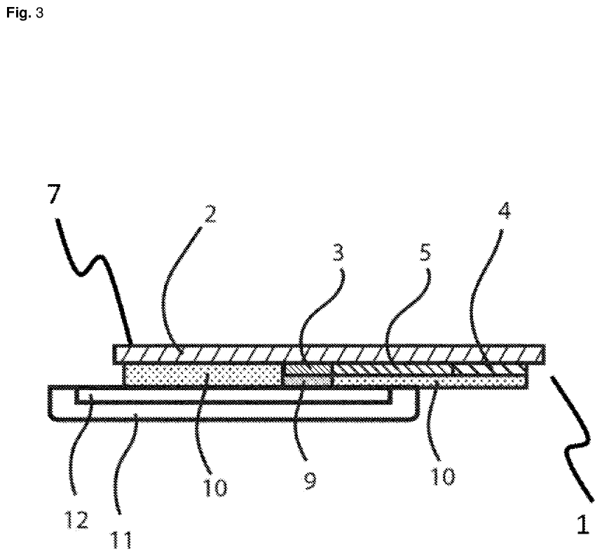

FIG. 3 shows a side view of an information carrier according to the present invention when brought in contact with a touch screen for reading the information encoded in the electrically conductive structure of the information carrier.

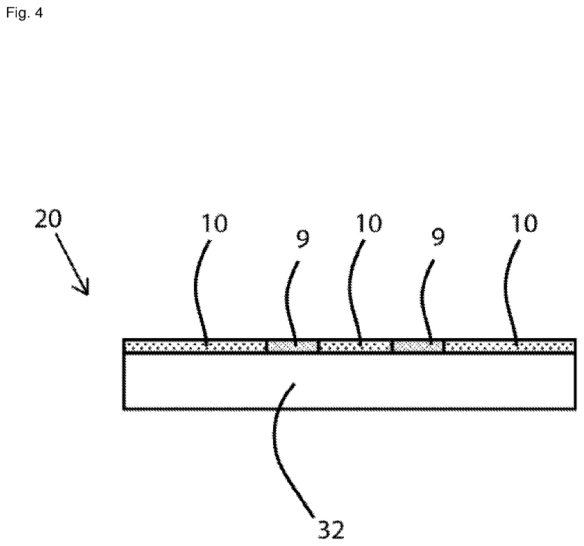

FIG. 4 shows a side view of a preferred embodiment of an electrically conductive object in the sense of the invention.

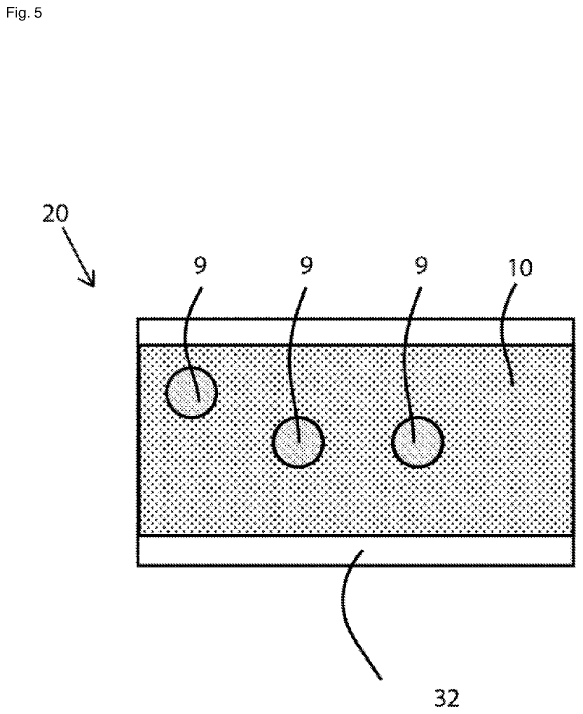

FIG. 5 shows a top view of a preferred embodiment of an electrically conductive object in the sense of the invention.

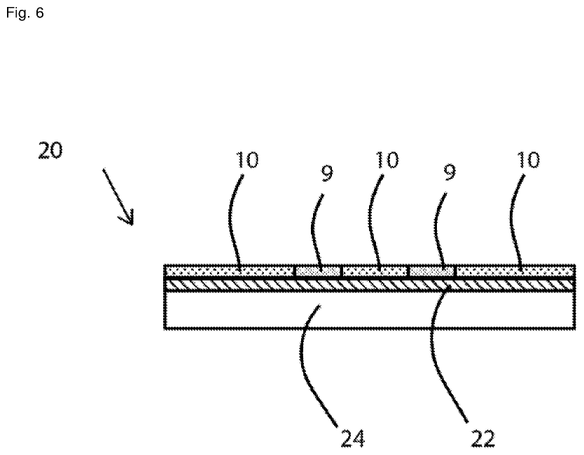

FIG. 6 shows a side view of a preferred embodiment of an object comprising an electrically conductive surface.

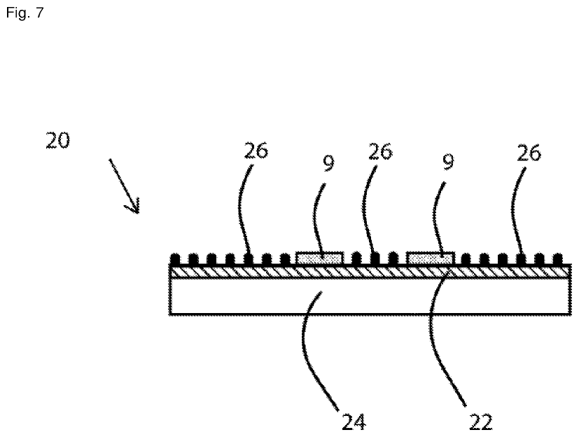

FIG. 7 shows a side view of a preferred embodiment of an object comprising an electrically conductive surface with low-k spacers.

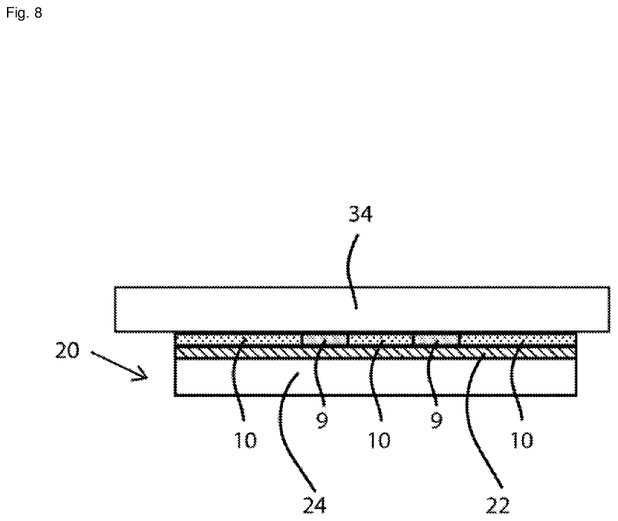

FIG. 8 shows a side view of a preferred embodiment of an object comprising an electrically conductive surface, wherein the detection of the information carrier is carried out by a capacitive reading device.

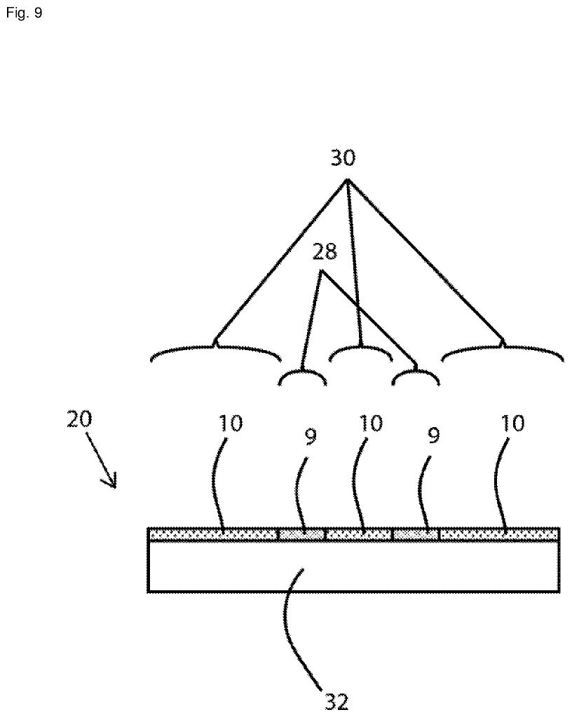

FIG. 9 shows a side view of a preferred embodiment of an electrically conductive object in the sense of the invention and, in particular, preferred embodiments of the first and second part.

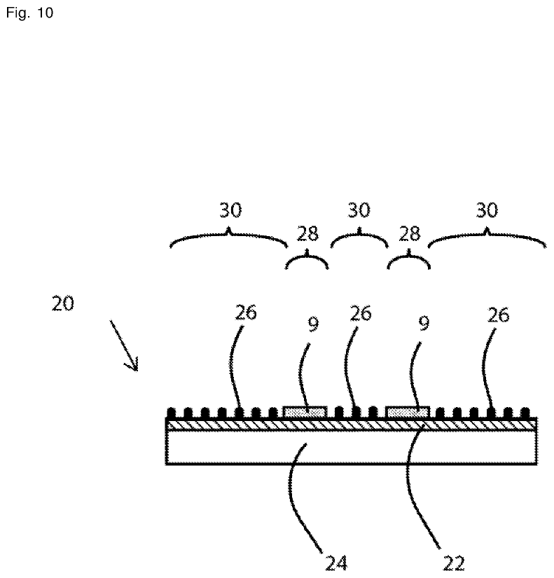

FIG. 10 shows a side view of a preferred embodiment of an object comprising an electrically conductive surface with low-k spacers and, in particular, preferred embodiments of the first and second part.

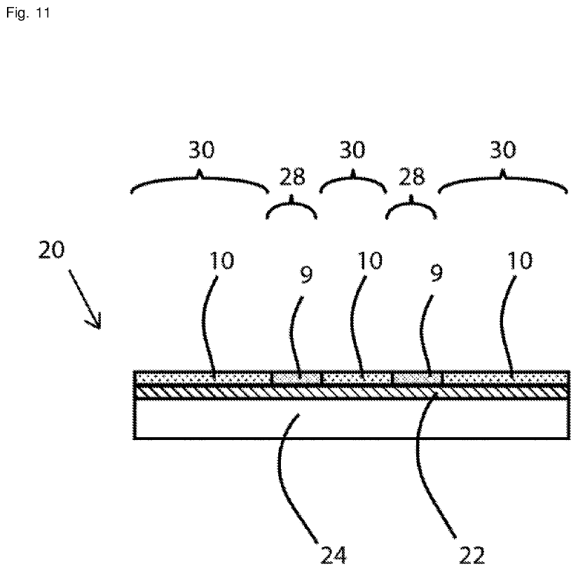

FIG. 11 shows a side view of a preferred embodiment of an object comprising an electrically conductive surface and, in particular, preferred embodiments of the first and second part.

FIG. 1 shows a side view of an information carrier (1) comprising an electrically non-conductive substrate (2). On the front side (6) of said substrate (2), an electrically conductive structure is printed which comprises three different electrically conductive areas, i.e. the touch points (3), a coupling area (4) and conductive traces (5). The detection of the touch points (3) is desired in the context of the present invention. The detection of the coupling area (4) and the conductive traces (5) is not desired in the context of the present invention. In the context of the present invention, it is preferred that the conductive traces (5) connect the touch points (3) with the at least one coupling area (4) of the electrically conductive structure and/or with each other. It is preferred that the capacitive impact of the coupling area (4) and in particular the conductive traces (5) on a touch screen (12) is reduced compared to the capacitive impact of the touch points (3) on a touch screen (12).

In order to provide an increased capacitive contrast between the touch points (3) on the one hand and the conductive traces on the other hand, the first and the third electrically conductive area of the information carrier (1) are overprinted with dielectric layers (9, 10) made from materials having different dielectric properties, in particular having different relative permittivities. It is preferred that the conductive traces (5) are overprinted with a dielectric material that has a low relative permittivity in the range smaller than 4. The touch points are preferably overprinted by a dielectric material having a relative permittivity larger than 10, more preferably larger than 20 and most preferably larger than 40. The dielectric material, which is used for overprinting the conductive traces (5), is preferably referred to as low-k dielectric material in the context of the present invention. It is preferred that the dielectric material, which is used for overprinting the touch points (3), is referred to as high-k dielectric material.

FIG. 2 shows a side view of an information carrier (1) where the method of manufacture has been completed, i.e. the dielectric layers (9, 10) have been applied to the information carrier (1). As can be seen from FIG. 2, which shows a preferred embodiment of this aspect of the invention, the dielectric layer (10), consisting of a low-k dielectric material, covers the conductive traces (5), the coupling area (4) and the electrically non-conductive substrate (2). Thereby, the capacitive traces that area are covered with the second dielectric material having a low-k relative permittivity, have a reduced capacitive impact on a touch screen (12). The touch points (3) are overprinted with the first dielectric layer (9), which is formed from a high-k material. These areas show an increased capacitive impact on a touch screen (12).

FIG. 3 shows a side view of an information carrier (1) according to the present invention when brought in contact with a touch screen (12) for reading the information encoded in the electrically conductive structure (3, 4, 5) of the information carrier (1). As can be seen from FIG. 3, the information carrier (1) is brought into contact with the touch screen (12) with the front side (6) of the information carrier (1) facing the surface of the touch screen (12).

FIG. 4 shows a side view of a preferred embodiment of an electrically conductive object (32) in the sense of the invention. An information carrier (20) is shown comprising an electrically conductive object (32) which serves as a substrate for two different dielectric layers (9, 10) which differ in their electric properties, in particular their relative permittivities ε. The first part (28) of the electrically conductive object (32) is overprinted with a layer (9) of a high-k material with a relative permittivity in a range of preferably larger than 10, more preferably larger than 20 and most preferably larger than 40. The electrically conductive object (32) further comprises a second part (30) which is overprinted with a layer (10) of a low-k material with a relative permittivity in a range of preferably smaller than 4, more preferably smaller than 3 and most preferably smaller than 2 in the dried state. It is preferred that the first part (28) of the electrically conductive surface (22) of an object (24) or the electrically conductive object (32) generates a first signal on a capacitive reading device (34) and that the second part (30) of the electrically conductive surface (22) of an object (24) or the electrically conductive object (32) generates a second signal on a capacitive reading device (34).

FIG. 5 shows a top view of a preferred embodiment of an electrically conductive object (32) in the sense of the invention. An information carrier (20) according to a preferred embodiment of the invention is shown comprising an electrically conductive object (32) which is covered by two different types of layers (9, 10) consisting of high/low-k material respectively. Layer (9) represents the first part (28) of the information carrier generating a first signal. The remaining part of the electrically conductive object (32) is overprinted with layer (10) comprising a low-k material and will preferably referred to as “second part” of the electrically conductive surface of an object or the electrically conductive object.

FIG. 6 shows a side view of a preferred embodiment of an information carrier (20) comprising an object (24) comprising an electrically conductive surface (22). The electrically conductive surface (22) comprises a first part (28) that is overprinted with a layer (9) comprising a high-k material with a relative permittivity ε1, whereas the second part (30) is overprinted by a layer (10) comprising low-k material with a relative permittivity ε2.

FIG. 7 shows a side view of a preferred embodiment of an information carrier (20) comprising an object (24) comprising an electrically conductive surface (22) with low-k spacer material (26) covering at least partially the second part (30) of the electrically conductive surface (22) of the information carrier (20). In the preferred embodiment of the invention shown in FIG. 7, the low-k spacer material (26) is formed from dots or small hills, wherein the space between said dots or hills is preferably filled with air. The first part (28) of the electrically conductive surface (22) of the information carrier (20) is covered by the layer (9) comprising high-k material with a relative permittivity ε1.

FIG. 8 shows a side view of a preferred embodiment of an object (24) comprising an electrically conductive surface (22), wherein the detection of the information carrier (20) is carried out by a capacitive reading device (34).

FIG. 9 shows a side view of a preferred embodiment of an electrically conductive object (32) in the sense of the invention and, in particular, preferred embodiments of the first (28) and second part (30) of the electrically conductive object (32).

FIG. 10 shows a side view of a preferred embodiment of an object (24) comprising an electrically conductive surface (22) with low-k spacers (26) and, in particular, preferred embodiments of the first (28) and second part (30. As can be seen from FIG. 10, the first part (28) is formed from the sub-areas of the dielectric layer (9) with high permittivity ε1, wherein the second part (30) is formed from the low-k-spacer material (26).

FIG. 11 shows a side view of a preferred embodiment of an object (24) comprising an electrically conductive surface (22) and, in particular, preferred embodiments of the first (28) and second part (30) of the electrically conductive surface (22).

### LIST OF REFERENCES

1 capacitive information carrier
2 electrically non-conductive substrate
3 electrically conductive area, i.e. touch points
4 electrically conductive area, i.e. coupling area
5 electrically conductive area, i.e. conductive trace
6 front side
7 back side
9 dielectric layer with high permittivity
10 dielectric layer with low permittivity
11 device with touch screen
12 touch screen
20 information carrier
22 electrically conductive surface of an object
24 object
26 low-k spacer material
28 first part of the electrically conductive surface of an object or the electrically conductive object
30 second part of the electrically conductive surface of an object or the electrically conductive object
32 electrically conductive object
34 capacitive reading device

1. (canceled)

2. A capacitive, planar information carrier (1) with a front side (6) and a back side (7), comprising an electrically non-conductive substrate (2) and a first, second and third electrically conductive area (3, 4, 5), wherein
a) the electrically conductive areas (3, 4, 5), are applied at least on the front side (6) of the information carrier (1),
b) a first dielectric layer (9) with a first relative permittivity el is arranged on top of the first electrically conductive area (3), and
c) a second dielectric layer (10) with a second relative permittivity ε2 is arranged on top of the third electrically conductive area (5).

3. Information The information carrier (1) according to claim 2, wherein the first dielectric layer (9) consists of a dielectric ink comprising a first relative permittivity ε1 of larger than 10.

4. Information The information carrier (1) according to that claim 2, wherein the second dielectric layer (10) consists of a dielectric ink comprising a second relative permittivity ε2 of smaller than 4.

5. The information n carrier (1) according to claim 2, wherein the electrically conductive areas (3, 4, 5) are in galvanic and/or electric contact.

6. The information carrier (1) according to claim 2, wherein the electrically non-conductive substrate (2) is made from flat, flexible, non-conductive materials selected from a group comprising paper, cardboard, plastic, wood-based material, composite, glass, ceramic, textile, leather, plastics and/or any combination thereof.

7. The information carrier (1) according to claim 2, wherein the electrically conductive areas (3, 4, 5) and the dielectric layers (9, 10) are manufactured with additive printing methods selected from a group comprising offset printing, flexo printing, gravure printing, screen printing and/or digital printing.

8. The information carrier (1) according to claim 2, wherein the electrically conductive areas (3, 4, 5) are manufactured with a chemical deposition method, a physical vapor deposition and/or a sputtering process.

9. The information carrier (1) according to claim 2, wherein the material of the electrically conductive areas (3, 4, 5) is selected of a group comprising metal particles, nanoparticles, in particular silver, gold, cooper, and/or aluminum, electrically conductive particles, in particular carbon black, graphite, graphene, ATO (antimony tin oxide), electrically conductive polymer layer, in particular Pedot, PANI (polyaniline), polyacetylene, polypyrrole, polythiophene, pentacene or any combination thereof.

10. A method for manufacture of an information carrier (1) according claim 2, comprising the following steps
a) providing an electrically non-conductive substrate (2),
b) applying a first, second and third electrically conductive area (3, 4, 5) on the electrically non-conductive substrate (2),
c) applying a first dielectric layer (9) comprising a dielectric ink comprising a first relative permittivity ε1 on top of the first electrically conductive area (3),
d) applying a second dielectric layer (10) comprising of a dielectric ink comprises a second relative permittivity ε2 on top of the third electrically conductive area (5).

11. The method according to claim 10, wherein the first dielectric layer (9) comprises a first relative permittivity ε1 of larger than 10 in the dried state.

12. The method according to claim 10, wherein the second dielectric layer (10) comprises a second relative permittivity ε2 of smaller than 4, preferably smaller than 3 and most preferably smaller than 2 in the dried state.

13. A method for the detection of an information carrier (1) according to claim 2 by a touch screen (12), wherein the front side (6) of the information carrier (1) is brought into contact with a touch screen (12).

14. A method for use of an information carrier (1) according to claim 2, wherein the first electrically conductive area (3) generates a local change of capacitance on a touch screen (12) by bringing into contact the information carrier (1) with a touch screen (12).

15. An information carrier (20) formed from an electrically conductive surface (22) of an object (24) or an electrically conductive object (32), wherein a first part (28) of the electrically conductive surface (22) of an object (24) or the electrically conductive object (32) is covered by a dielectric layer (9) with a first relative permittivity el generating a first signal on a capacitive reading device (34), wherein a second part (30) of the electrically conductive surface (22) of an object (24) or the electrically conductive object (32) is covered by a dielectric layer (10) with a second relative permittivity ε2 and/or a low-k spacer material (26), generating a second signal on the capacitive reading device (34), wherein the first (28) and the second (30) part form the electrically conductive surface (22) of an object (24) or the electrically conductive object (32) that is read by the capacitive reading device (34).

16. A method or use of an information carrier (20) according to claim 15, wherein the first signal generated by the first part (28) of the electrically conductive surface (22) of an object (24) or the electrically conductive object (32) is different from the second signal generated by the second part (30) of the electrically conductive surface (22) of an object (24) or the electrically conductive object (32).

17. A method for manufacture of an information carrier (20) according to claim 15 comprising the following steps
a) providing an electrically conductive surface (22) of an object (24) or an electrically conductive object (32), and
b) applying a dielectric layer (9) with a first relative permittivity ε1 onto the first part (28) of the electrically conductive surface (22) of an object (24) or the electrically conductive object (32).

18. A method for manufacture of an information carrier (20) according to claim 15 comprising the following steps
a) providing an electrically conductive surface (22) of an object (24) or an electrically conductive object (32),
b) applying a dielectric layer (9) with a first relative permittivity ε1 onto the first part (28) of the electrically conductive surface (22) of an object (24) or the electrically conductive object (32), and
c) applying a dielectric layer (10) with a second relative permittivity ε2 and/or a low-k spacer material (26) onto the second part (30) of the electrically conductive surface (22) of an object (24) or the electrically conductive object (32).

19. A method for the detection of an information carrier (20) according to claim 15 by a capacitive reading device (34), wherein the information carrier (20) is brought into contact with the capacitive reading device (34).
